(19) United States
(12) Patent Application Publication
(10) Pub. No.: US 2009/0152059 A1
(43) Pub. Date: Jun. 18, 2009

(54) Rotational Resistance Apparatus

(76) Inventors: Nathan Paul Womack, Lafayette, CO (US); Edmund Charles Burke, JR., Diamond, OH (US); John Harold Burke, Cincinnati, OH (US)

Correspondence Address: JACKSON ESQUIRE;ROGER A. JACKSON, 209 KALAMATH STREET, UNIT 9, DENVER, CO, 80223-1348, US

(21) Appl. No.: 11/954,795

(22) Filed: Dec. 12, 2007

(51) Int. Cl. F16D 13/22; A63B 21/015

(52) U.S. Cl. 188/266; 482/119

(57) ABSTRACT

A rotational resistance apparatus and method of use is disclosed to control movement of a carriage across a surface. The apparatus includes a disc having an axial rotational axis, an axial first end portion, and second end face portion that is substantially perpendicular to the axial rotational axis. The first end portion rotationally engages a rotating element of the carriage. Also included, is a cover having an axial longitudinal axis, an axial outer end portion that removably engages a frame of the carriage, and an axial inner face portion positioned substantially perpendicular to the longitudinal axis. The longitudinal and axial rotational axes are approximately co-axial and the inner face portion and the second end face portion are in a selected rotational frictional contact. Further included, is a first structure for selectable axial urging of the cover toward the disc, being operational to further selectably alter the selected rotational frictional contact.

### TECHNICAL FIELD

The present invention generally relates to an apparatus for manually moving an item across a surface or accomplishing exercise either in a traditional exercise or working out environment, such as a gym, health club, spa, or other type of facility for exercise or working out or in the outdoors. More particularly, the present invention is a rotational resistance apparatus that is adapted to be adjacent to a rotating shaft such as a bicycle type crank or a bicycle wheel hub to facilitate exercise in a convenient time and place, thus allowing the individual to enjoy the health benefits of exercise.

### BACKGROUND OF INVENTION

The health benefits of exercise are well known and applicable to all ages of individuals, including cardiovascular improvement, muscle strengthening, stretching, increased blood circulation, better coordination, sharper motor abilities, flexible joint mobility, better bone health, general overall wellness, and the like. One problem is that as an individual typically moves from being a child to being an adult, their physical activity levels decline just when maintaining good health is at its most important and as an individual ages, typically their exercise levels decline which can work against maintaining good health, thus just when an individual should be exercising more and being active, their exercise and activity levels tend to decrease. Children are typically normally active in going places (i.e. walking, running, skateboarding, or riding a bike), playing active games in their spare time, such as football, soccer, baseball, tag, hide and seek, and the like, plus being in school, children are also active in physical education classes and after school hours sports leagues. Thus, as children we are normally plenty active and in the best of health due to our young age. However, as we become adults, societal norms tend to drive us into a much more sedentary lifestyle, for instance by having a car, we tend to walk very little, nor ride a bicycle much, and as an office worker we tend to sit at a desk for long periods of time, sit in meetings, sit on airplanes, and then go out for high fat and calorie content meals at high end restaurants, thus as a result most adults tend to gain weight by consuming more calories coupled with a lower activity lifestyle, just when our bodies should be in better shape to compensate for aging we typically get in worse shape.

Although the benefits of exercise especially for adults are acknowledged by most everyone for weight control, maintaining agility, preventing diabetes, preventing joint stain from excessive body weight, preventing higher various internal organ workloads (especially the heart) from excessive body weight, and so on, few adults are active enough to maintain even a recommended weight, typically being only about one—fourth of the adult population is not overweight in the United States. So the question to ask is, why don't the majority of adults exercise especially if the health benefits are widely known? One probable answer is that available time and convenience are a problem for engaging in an exercise program, as most adults have a full time job, a family, and other interests that all together consume most of an adults time. Thus, a potentially helpful solution is to minimize the time and convenience obstacles to allow for an exercise program to be possible for a working adult. This is where bicycling comes into play as a portion of an adult's exercise program either as basic transportation, for fun, in competitions, or for those so inclined “spinning” on a stationary bike at a gym type facility or at home. Of course the endurance and strength required for bicycling in the outdoors is limited by the amount and type of terrain that the bicyclist rides over and in the “spinning” scenario control over the strength and endurance for the bicyclist is by the variable rotational resistance placed upon the crank and the amount of time an individual spins. In addition, some “spinning” bikes have movement of the bike frame and/or handlebars in X, Y, or Z axes or combinations of these axes also with the possibility of having resistance in the bike frame and/or handlebar movement in an attempt to more simulate actual outdoor bicycling thus affording better physical conditioning. Also, “spinning” being especially applicable in inclement outdoors weather or allowing the individual “spinning” or who rides the stationary bicycle the added ability to watch TV, play video games, or read a book, magazine, newspaper or the like.

This has not gone unnoticed in the prior art either as there are a number of “spinning” stationary type bikes or equipment that adapts a conventional “outdoors” bike into a stationary “spinning” bike for indoors use. In the pure spinning bike category, i.e. bikes that are only designed for gym or home use that are solely stationary, in U.S. Pat. No. 4,206,914 to Lee disclosed is a work control apparatus in a stationary exercising bicycle that controls the rotational resistance on the stationary bike thus controlling the crank pedaling force for the individual using the stationary bicycle. In Lee, the apparatus is a roller wheel that rotationally engages the resilient outside diameter of the rotating wheel of the stationery bicycle, wherein the rotational resistance is varied by the contact pressure or force of the roller as against the outside diameter of the rotating wheel through the roller being mounted on a pivotal connection with a tension adjustment screw in a fulcrum or seesaw type arrangement. Thus, in Lee the higher the roller contact pressure the more deflection of the resilient outside diameter of the rotating wheel and thus more rotational resistance, being somewhat similar to an automotive tire contacting the road while carrying a light load or low downward force against the road as opposed to a heavy load or high downward force against the road, and thus increasing the rolling resistance or road friction between the tire and the road due to the higher load respectively.

Further, in the same area in U.S. Pat. No. 3,501,142 to Johansson disclosed is a rotational resistance apparatus for a stationary bicycle wherein a band partially circumferentially encompasses the outside diameter of a rotating disk that is rotatably attached to a stationary bicycle crank wherein the longitudinal tension of the band is variable thus changing the frictional force as between the band surface and the outside diameter of the rotating desk thus resulting in a change of the crank pedal force that the individual using the Johansson apparatus experiences. Continuing onward, in U.S. Pat. No. 3,192,772 to Tarter disclosed is a work calibrated exercising apparatus that is essentially again a piece of varying rotational resistance equipment that includes basically a variable rotational resistance apparatus highly similar to Lee with the addition of a chain tension measuring apparatus that also outputs data on the linear speed of the chain and thus is able to calculate the work or power output of the individual on the stationary exercising bicycle as the chain is the rotatable connection between the crank and the wheel.

In moving to the rotational resistance equipment in the prior art that is adapted to create bicycle crank variable pedal force resistance to a conventional outdoors type of bicycle, thus converting the conventional bicycle to a stationary or “spinning” bicycle, in United States patent application publication number US2005/0209064A1 to Peterson et al., disclosed is an apparatus that affixes to a conventional bicycle and allows for lateral movement of the bicycle thus pivoting about an imaginary tire surface contact patch line, thus recognizing the need to more closely simulate actual outdoors bicycle riding having a spring/damper system for controlling the pivoting movement. In Peterson et al., the bicycle wheel rotational resistance is a roller that is in rotational contact with an outside diameter of the wheel, wherein the roller rotational resistance is from fluid, magnetic, or air means. Further, to the same inventor Peterson et al., in United States patent application publication number US2006/0234839A1 to again Peterson et al., disclosed is a cyclist training system that is similar to Peterson et al., '064 in the overall function by facilitating pivotal movement of the bicycle that uses different structure to act as a spring and damper, by using a composite resilient block instead of actual springs and shock absorber dampers for simplicity.

Continuing, in U.S. Pat. No. 5,944,637 to Stickler et al., disclosed is a resistance device for a bicycle trainer that includes an A type frame structure that utilizes a fluid resistance unit for rotational resistance of the bicycle rear wheel. In Stickler et al., the fluid resistance unit is constructed of an impeller that is rotating in a fluid within a sealed housing, in essence acting as a centrifugal pump by the impeller pumping the fluid to create rotational work input at the shaft that is driven by the bicycle rear wheel. Also in Stickler et al., the rotational resistance is varied by controlling the amount of fluid immersion of the impeller, with a fully fluid immersed impeller equaling a high resistance level and a non fluid immersed impeller equaling a low resistance level. Using the fluid as a means for resistance in Stickler et al., does provide for a quiet and smooth apparatus, however, having the drawbacks of mechanical complexity and potential for fluid leakage from the shaft and housing. Note, however, that Stickler et al., does not recognize the problem of not allowing the stationary bicycle lateral pivotal movement to better simulate the riding of a conventional bicycle in the outdoors as was recognized in Peterson et al., '064 and '839.

Further, in U.S. Pat. No. 5,916,068 to Chisholm et al., disclosed is a variable resistance device that is similar in design as Stickler et al., by the use of a fluid resistance means, however, Chisholm et al., utilizes a variable distance between plates that are rotating in a fluid to control the amount of rotational resistance, wherein the greater distance between the plates results in more rotational resistance basically due to a greater quantity of fluid having to be spun with the disc when the discs are further apart. In Chisholm et al., one advantage is that the rotational resistance is consistent being irrelevant to the direction of rotation of the disc, this is opposed to an impeller type system as described in Peterson et al., '064 and '839, wherein the rotational resistance is definitely unidirectional, such that rotational resistance in one direction of rotation is different than rotational resistance in an opposing direction of rotation even with the same fluid immersion amount for the impeller due to impeller vane orientation differences. However, the same fluid containment drawbacks apply to Chisholm et al., which apply to Peterson et al., '064 and '839 as previously described.

Next, in U.S. Pat. No. 5,520,401 to Mohseni disclosed is a step drive cycle that operates by vertically reciprocating movement of the riders feet, similar to a “Step Master” exercise machine wherein the rider does not have a seat and alternates putting weight of each of the right and left foot that drives pivoting platforms that are connected to drive pulleys through drive belts to rotate the cycle drive wheel. Mohseni also includes a spring and damper system that controls the motion of the reciprocating movement, thus in effect adding to the resistance of the quasi pedaling action of the cycle. However, the spring and dampener system is to primarily limit the range of motion of reciprocating movement and has viscous dampening, i.e. a piston and oil filled cylinder type wherein the oil is forced through an orifice, thus slowing the movement down. Next, in U.S. Pat. No. 4,913,684 to Mantovaara et al., disclosed is an automatic variable transmission for vehicles being primarily for bicycles that include convex cup discs that face one another that can move closer together or further apart. Wherein in Mantovaara et al., a V belt drive is positioned between the discs and when the discs move further apart the effective belt circumference reduces and when the discs move closer together the effective belt circumference increases thus the ratio of the belt changes from high to low gear respectively for a fixed circumference mating pulley (diameter and position) with a belt tensioner to take up the tension slack from the effective belt circumference changes. Mantovaara et al., uses fluid pressure to move the discs together or apart thus changing the belt ratio selectively.

Thus, from the prior art it can be seen that the bicycle arts rotational resistance apparatus equipment is either designed for a custom stationary bicycle or is to be adapted to a conventional outdoors type bicycle that is solely used functionally as a stationary type bicycle. Therefore in either scenario the design limitations are considerably more relaxed as there are no substantial size and weight restrictions, also typical utilities are available such as 110 VAC electrical power, tap water, and the like, and further the options for rotational coupling to the resistance apparatus to the pedal crank are numerous. All as opposed to adapting a rotational resistance apparatus to a conventional outdoors bicycle for outdoor terrain use, wherein there are size and weight limitations, no utilities available, and limited means for rotational coupling the pedal crank to the apparatus. In addition, the conditioning that the rider obtains with the outdoors bicycle over outside terrain is generally better, as there is the previously mentioned pivotal bicycle movement being recognized in Peterson et al., '064 and '839. However, a problem exists as there is no easy control of the pedal crank force outside of what the actual outdoors terrain provides, thus limiting the conditioning options available to the conventional outdoors bicycle rider.

What is needed is a rotational resistance apparatus that is easy and simple to use, is low cost, and is adaptable to either a conventional “outdoors” type bicycle for adding a selectable rotational resistance to the wheel and thus the pedal crank to enable the individual riding the conventional bicycle to obtain the benefit of having a more intense workout even while riding on level or downwardly slopping outdoors terrain or while riding in a group of other riders that are less conditioned so as to maintain a “group pace” or riding speed. This enables the better conditioned rider(s) having the ability to utilize higher crank pedal force with the rotational resistance apparatus as opposed to the less conditioned rider(s) riding in the same group over the same terrain that either have the rotational resistance set lower or off. In addition, when bicycle riding outdoors in a group, wherein there is a child or a portion of the group is children, the rotational resistance apparatus can be used as a speed governor to help limit the speed that the child can ride the bicycle outdoors at. Noting that the use of adapting a bicycle wheel rotational resistance apparatus on a conventional outdoors type of bicycle requires a size and configuration that must consider minimizing size and weight and how to rotationally couple the apparatus to a moving bicycle, wherein a rotational resistance apparatus that is adapted for a “spinning” type stationary bicycle need not be concerned with size and weight considerations and has numerous options for rotational coupling to the pedal crank. Thus, in designing a rotational resistance apparatus to be adapted to both a conventional outdoors type bicycle and a stationary “spinning” type bicycle requires more constraining design limits from application to the conventional outdoors type bicycle. Further, the rotational resistance apparatus should be adaptable to carriages that roll across a surface such as a wheelchair, a trolley cart, and the like for controlling the rolling resistance, such as in a situation where a wheelchair is being rolled down a long hill and for safety an increased rolling resistance is desired, as opposed to the currently available full on or full off brake system that doesn't allow for modulating speed during the dynamic movement of the carriage across the surface.

### SUMMARY OF INVENTION

The present invention of a rotational resistance apparatus to further control movement of a carriage across a surface, includes a disc having an axial rotational axis, the disc having an axial first end portion and an axial second end face portion that is substantially perpendicular to the axial rotational axis. Wherein, the first end portion of the disc is adapted to rotationally engage a rotating element of the carriage. Also included, is a cover having an axial longitudinal axis, the cover having an axial outer end portion that is adapted to removably engage a frame of the carriage and an axial inner face portion that is substantially perpendicular to the longitudinal axis. Wherein the longitudinal axis is approximately co-axial to the axial rotational axis and the cover axial inner face portion and the disc axial second end face portion are in a selected rotational frictional contact. Further included, is a first means for selectable axial urging of the cover toward the disc along the axial longitudinal axis that is operational to further selectably alter the selected rotational frictional contact. This results in the rotational resistance apparatus being operational to further control movement of the carriage across the surface via the selected rotational frictional contact of the rotating element as between the surface and the frame of the carriage.

These and other objects of the present invention will become more readily appreciated and understood from a consideration of the following detailed description of the exemplary embodiment(s) of the present invention when taken together with the accompanying drawings, in which;

### BRIEF DESCRIPTION OF DRAWINGS

FIG. 1 shows a cross sectional view of the rotational resistance apparatus for use in a carriage;

FIG. 2 shows a cross sectional view of the rotational resistance apparatus with the cover, washer, and shouldered sleeve removed to substantially separate out the rotating portion of the rotational resistance apparatus from the static portion of the rotational resistance apparatus;

FIG. 3 shows a close up perspective view of the rotational resistance apparatus as installed in the carriage, or specifically a rear bicycle wheel;

FIG. 4 shows an expanded perspective view of the rotational resistance apparatus as installed in the carriage, or specifically a rear bicycle wheel;

FIG. 5 shows a complete perspective view of the rotational resistance apparatus in use as installed in the carriage, or specifically a rear bicycle wheel;

FIG. 6 shows a cross sectional view of the rotational resistance apparatus for use in the physical conditioning machine, specifically a “spinning” stationary exercise bike that includes the second means for selectable axial urging of the cover toward the disc;

FIG. 7 shows a cross sectional view of the rotational resistance apparatus for use in the physical conditioning machine, specifically a “spinning” stationary exercise bike that further includes the third means for selectable axial urging of the disc toward the cover;

FIG. 8 shows a close up perspective view of the rotational resistance apparatus as installed in the physical conditioning machine, or specifically a “spinning” stationary exercise bike; and

FIG. 9 shows a complete up perspective view of the rotational resistance apparatus as installed in the physical conditioning machine, or specifically a “spinning” stationary exercise bike.

### REFERENCE NUMBERS IN DRAWINGS

30 Rotational resistance apparatus
32 Further controlling movement of the carriage 34 across the surface 44
34 Carriage
36 Frame of carriage
38 Rotating element of the carriage 34
39 Rear bicycle wheel as the rotating element 38
40 Wheel hub of the rotating element 38
42 Rotational attachment of the rotating element 38 to the frame 36
43 Stationary axle of the rotating element 38
44 Surface
45 Rotational resistance movement of the rotating element 38
46 First velocity of the carriage 34 across the surface 44
48 Second selected velocity of the carriage 34 across the surface 44
50 Disc
52 Axial rotational axis of disc 50
54 Axial rotating structure axis of disc 50
56 Axial first end portion of disc 50
58 Axial second end face portion of disc 50
60 Substantially perpendicular relationship between the axial second end face portion 58 of disc 50 to the axial rotational axis 52
61 Substantially perpendicular relationship between the axial second end face portion 58 of disc 50 to the axial rotating structure axis 54
62 Rotational engagement of the first end portion 56 of the disc 50 to the rotating element 38 of the carriage 34
64 Cover
66 Axial longitudinal axis of the cover 64
68 Axial outer end portion of the cover 64
70 Removable engagement of the axial outer end portion 68 of the cover 64 to the frame 36 of the carriage 34
72 Axial inner face portion of the cover 64
74 Substantially perpendicular relationship of the axial inner face portion 72 of the cover 64 to the longitudinal axis 66
76 Coaxial relationship approximating between the longitudinal axis 66 and the axial rotational axis 52
78 Selected rotational frictional contact between the axial inner face portion 72 of the cover 64 and the axial second end face portion 58 of the disc 50
80 First means for selectable axial urging of the cover 64 toward the disc 50
82 Washer
84 Shouldered sleeve
86 Adaptation of the shouldered sleeve 84 to the removably engage the carriage frame 36
88 First member to selectably axially urge the shouldered sleeve 84 and the cover axial outer end portion 68 axially apart
90 Selectable axial urging or normal force between the shouldered sleeve 84 and the cover 64 axially apart from one another
92 Serrated surface interface of the shouldered sleeve 84 to the carriage frame 36
94 Plane
96 Substantially perpendicular relationship of the plane 94 to the axial longitudinal axis 66 of the cover 64
98 Removable engagement of the serrated surface 92 for the shouldered sleeve 84
100 First manually adjustable screw
102 Threadable engagement of the first manually adjustable screw 100 to the shouldered sleeve 84
104 Cavity disposed on the cover axial outer end portion 68
106 Rotational reception of the first manually adjustable screw 100 into the cavity 104
108 Interference fit between the disc first end portion 56 and the wheel hub 40
110 Substantially cylindrical configuration of the interference fit 108
111 Rotational resistance apparatus alternative embodiment
112 Resistive force as against exercise movement
114 Physical conditioning machine
116 Housing of the physical conditioning machine 114
118 Rotating structure of the physical conditioning machine 114
120 Rotating structure of the physical conditioning machine in 114 a static state
122 Rotational engagement of the first end portion 56 of the disc 50 to the housing 116 of the physical conditioning machine 114
124 Rotational engagement adaption of the axial outer end portion 68 of the cover 64
125 Substantially perpendicular relationship of the axial inner face portion 72 of the cover 64 to the axial rotating structure axis 54
126 Second means for selectable axial urging of the cover 64 toward the disc 50
128 Selectable resistive force as against exercise movement in the physical conditioning machine 114
130 Annular ring
132 Adaptation of the annular ring 130 to attach to the rotating structure 118 of the physical conditioning machine 114
134 Second member to selectably axially urge the annular ring 130 and the cover 64 axial outer end portion 68 apart from one another
135 Selectable axial urging or normal force between the annular ring 130 and the cover 64 axially apart from one another
136 Cavity disposed on the cover 64 axial outer end portion 68
137 Threadable engagement of the second manually adjustable screw 138 to the annular ring 130
138 Second manually adjustable screw that is manually axially adjustable wherein the second screw is threadably engaged 137 to the annular ring 130 and the second screw is also rotationally received into the cavity disposed on the cover axial outer end portion 68
139 Rotational reception of the second manually adjustable screw 138 into the cavity 136
140 Third means for selectable axial urging of the disc 50 toward the cover 64
141 Axial bearing of third screw 144 against disc 50 axial first end portion 56
142 Selectable rotational frictional contact of the rotating structure 118 relative to the housing 116 of the physical conditioning machine 114
143 Threadable engagement of the third manually adjustable screw 144 to the housing 116
144 Third manually adjustable screw that is manually axially adjustable wherein the third screw 144 is threadably engaged 143 to the housing 116 and the third screw 144 is also in axial bearing 141 as against the disc 50 axial first end portion 56
146 Positioning the disc 50 to rotationally engage 62 the rotating element 38 of the carriage 34
148 Positioning the cover 64 to removably engage 70 the frame 36 of the carriage 34
150 Adjusting the first means 80 for selectable axial urging 90 of the cover 64 toward the disc 50 for initial light rotational frictional contact between the cover 64 axial inner face portion 72 and the disc 50 axial second end face portion 58
152 Moving the carriage 34 across the surface 44 utilizing a selected manual motivation level resulting in recording the first velocity 46 of the carriage 34 across the surface 44
154 Adjusting the first means 80 for selectable axial urging 90 of the cover 64 toward the disc 50 for a frictional contact between the cover axial inner face portion 72 and the disc axial second end face portion 58 that results in the selected second velocity 48 of the carriage 34 across the surface 44
156 Adding a washer 82 in between the cover axial inner face portion 72 and the disc 50 axial second end face portion 58
158 Adjusting the second means 126 for selectable axial urging of the cover 64 toward the disc 50 for initial light rotational frictional contact between the cover 64 axial inner face portion 72 and the disc 50 axial second end face portion 58
160 Adjusting the second means 126 for selectable axial urging of the cover 64 toward the disc 50 for a frictional contact between the cover axial inner face portion 72 and the disc axial second end face portion 58 that results in the selected rotational frictional contact 142
162 Remote adjustment structure for third means 140 for selectable axial urging of the disc 50 toward the cover 64
164 Adjusting the third means 140 for selectable axial urging of the disc 50 toward the cover 64 for initial light rotational frictional contact between the cover 64 axial inner face portion 72 and the disc 50 axial second end face portion 58
166 Adjusting the third means 140 for selectable axial urging of the disc 50 toward the cover 64 for a frictional contact between the cover axial inner face portion 72 and the disc axial second end face portion 58 that results in the selected rotational frictional contact 142

### DETAILED DESCRIPTION

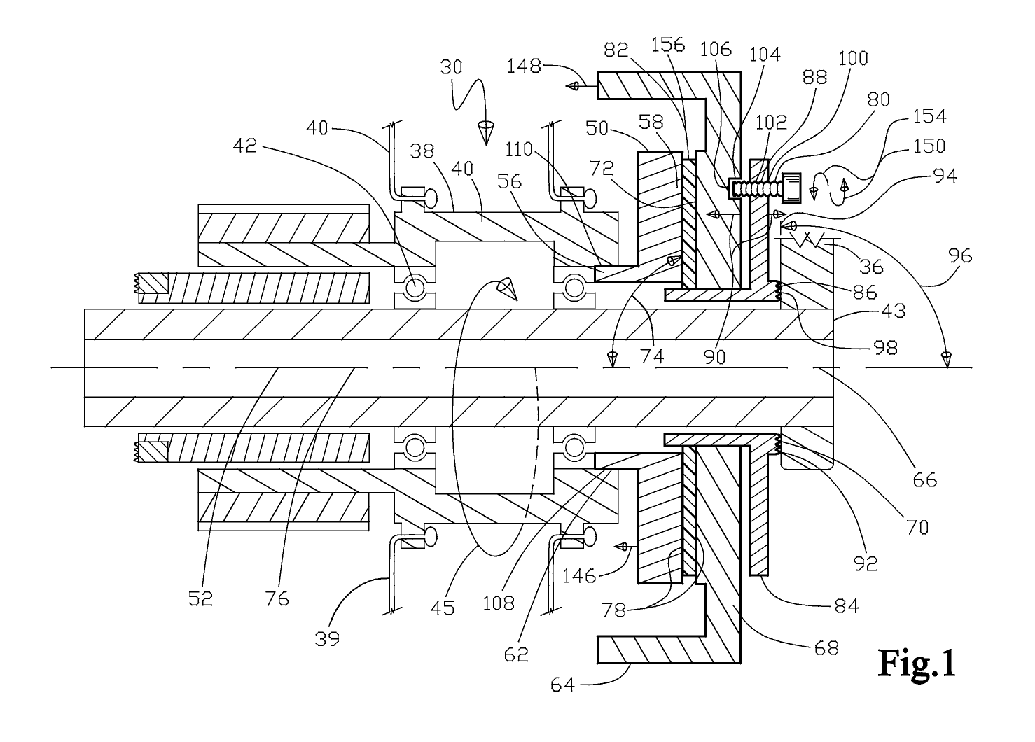

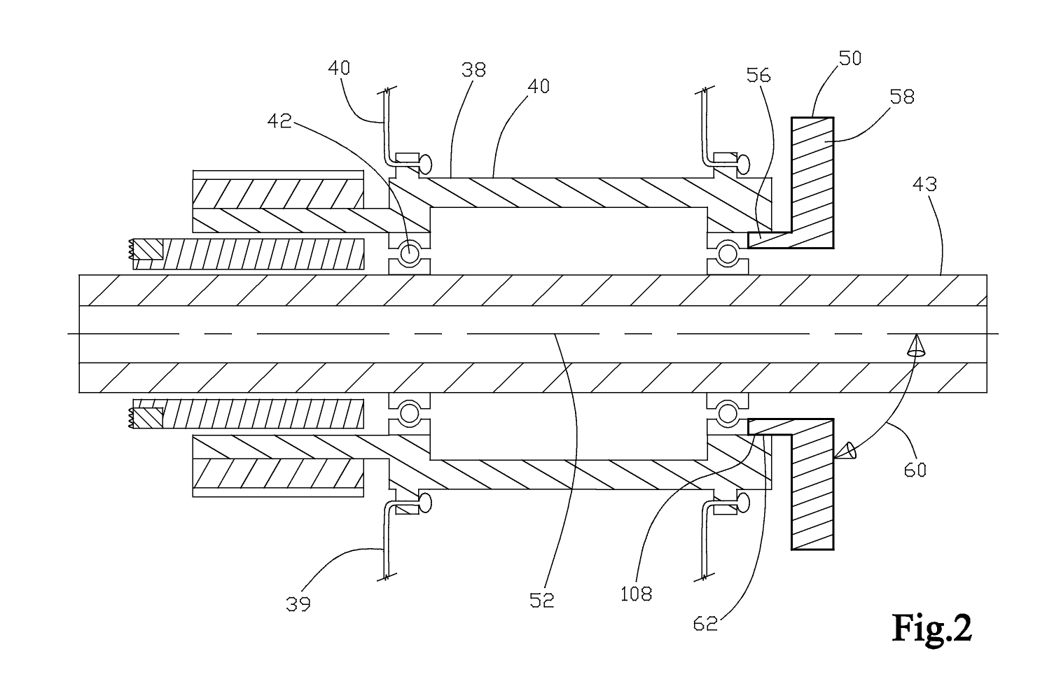

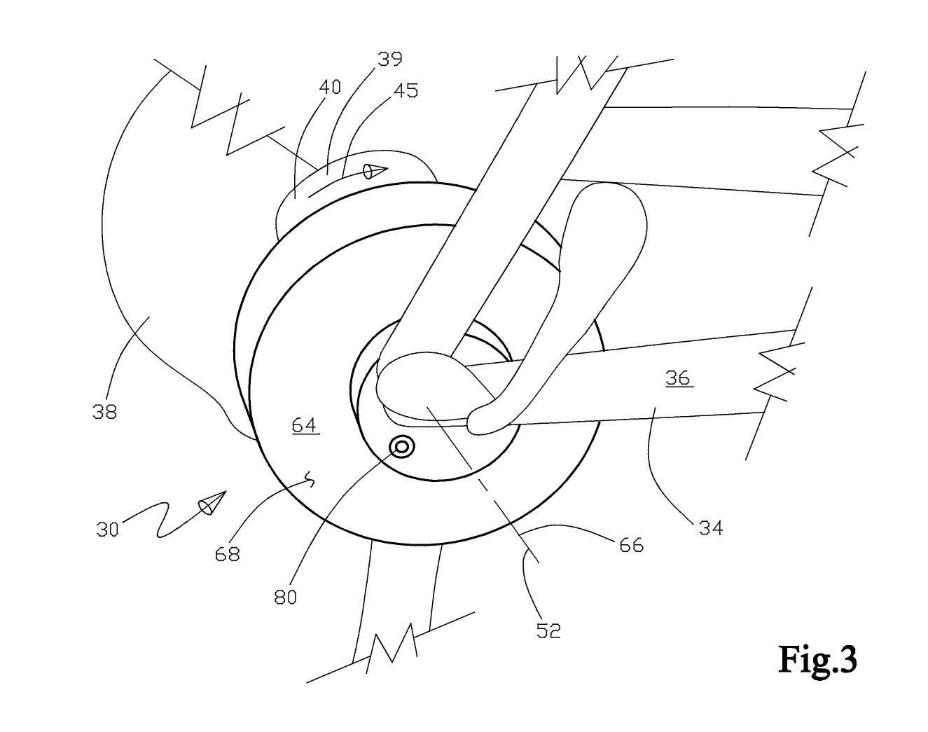

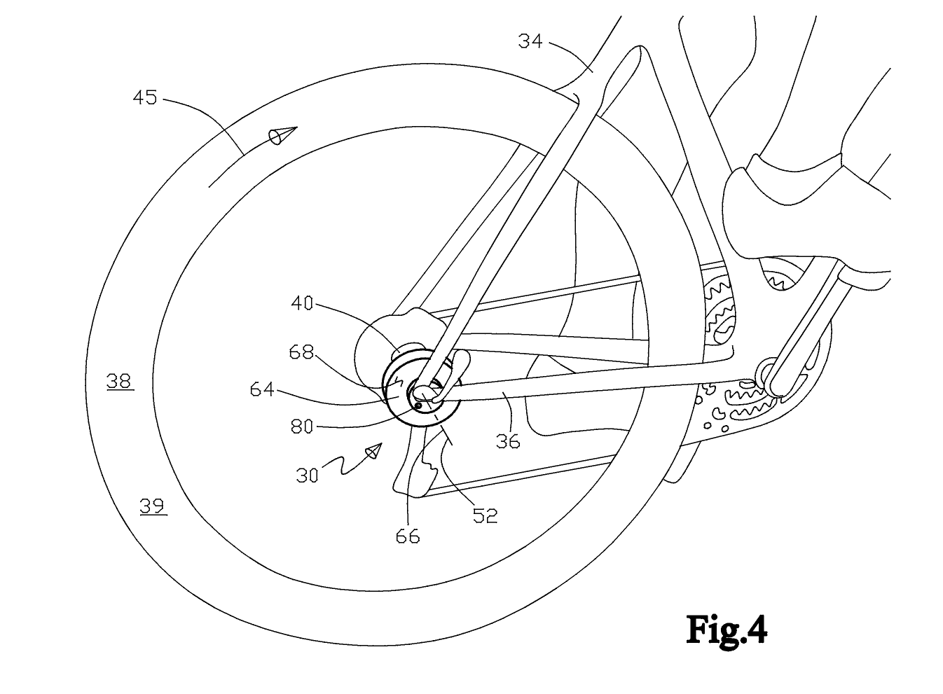

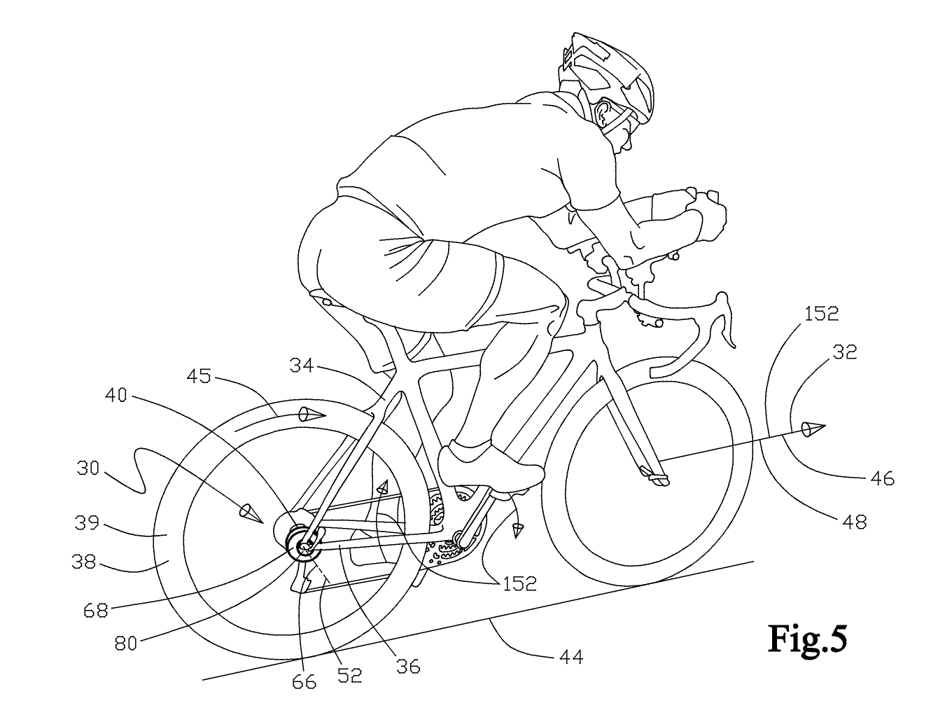

With reference to FIG. 1 shown is a cross sectional view of the rotational resistance apparatus 30 for use in a carriage 34 and FIG. 2 shows a cross sectional view of the rotational resistance apparatus 30 with the cover 64, washer 82, and shouldered sleeve 84 removed to substantially separate out the rotating portion 45 of the rotational resistance apparatus 30 from the static portion, including the carriage frame 36 of the rotational resistance apparatus 30. Further, FIG. 3 shows a close up perspective view of the rotational resistance apparatus 30 as installed in the carriage 34, or specifically a rear bicycle wheel 39 and FIG. 4 shows an expanded perspective view of the rotational resistance apparatus 30 as installed in the carriage 34, or specifically a rear bicycle wheel 39. Next, FIG. 5 shows a complete perspective view of the rotational resistance apparatus 30 in use as installed in the carriage 34, or specifically a rear bicycle wheel.

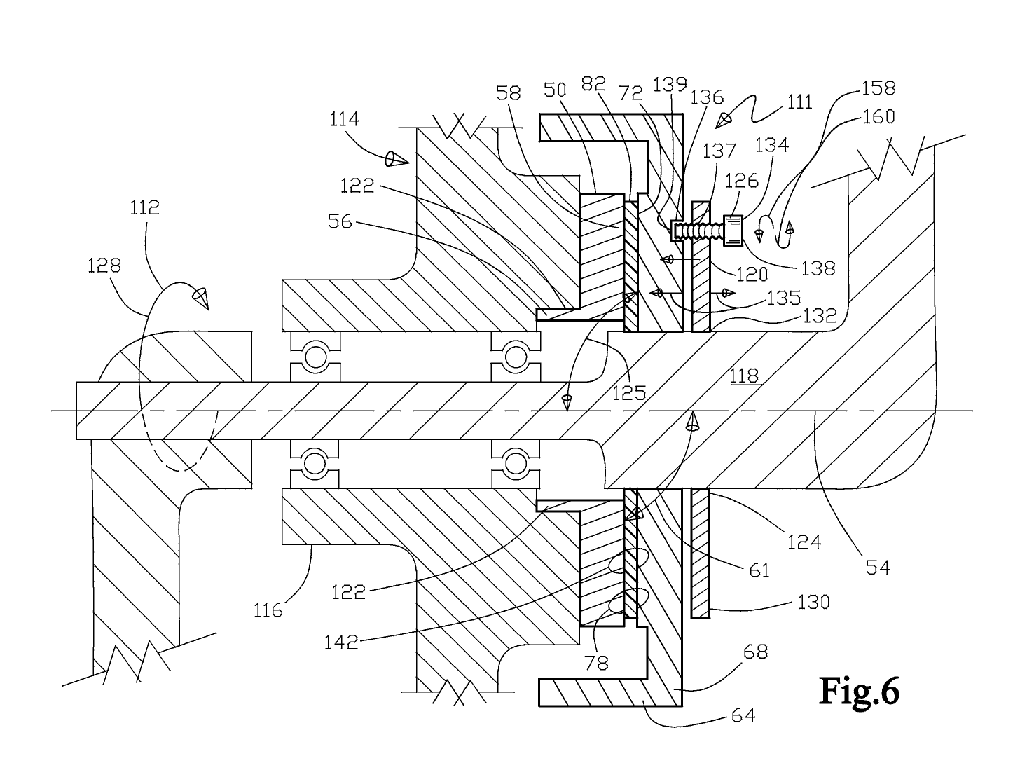

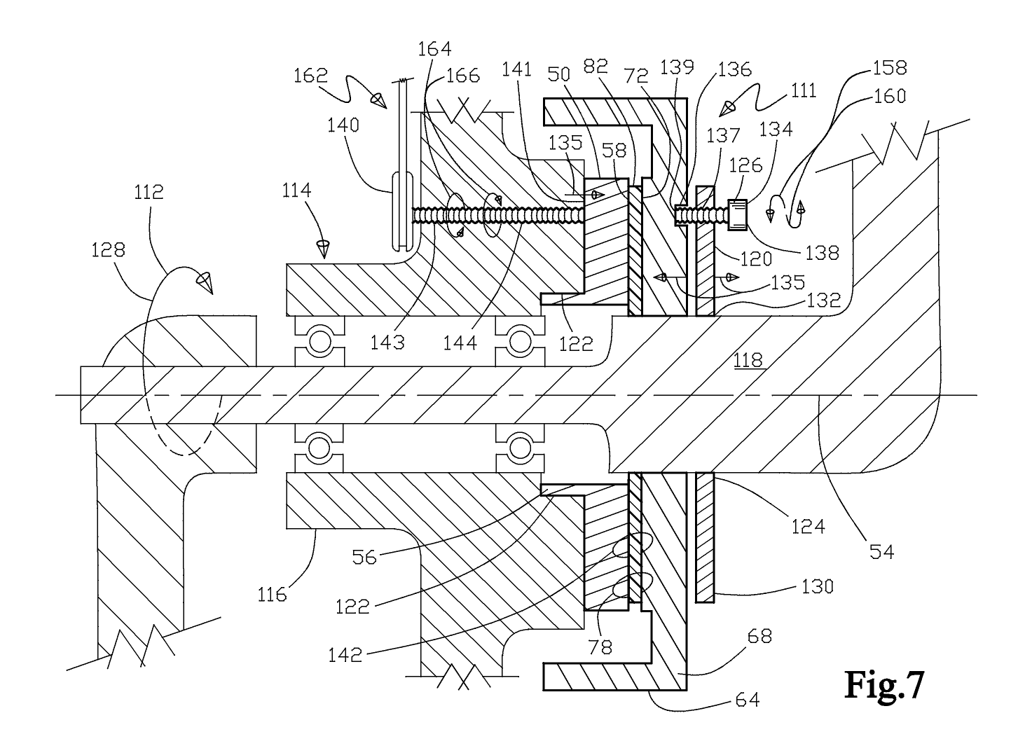

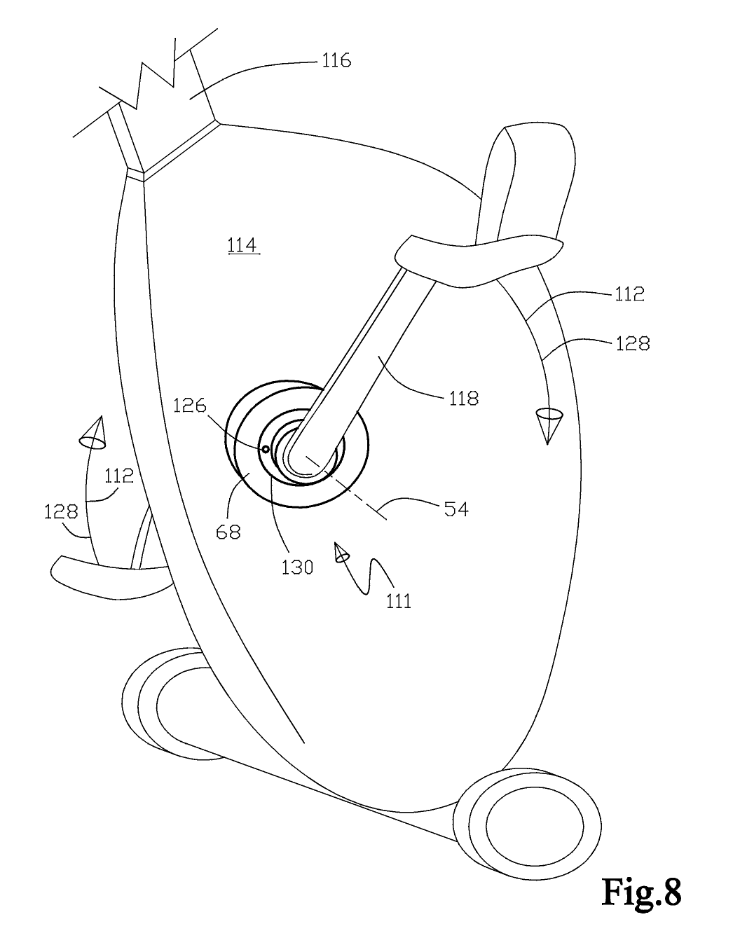

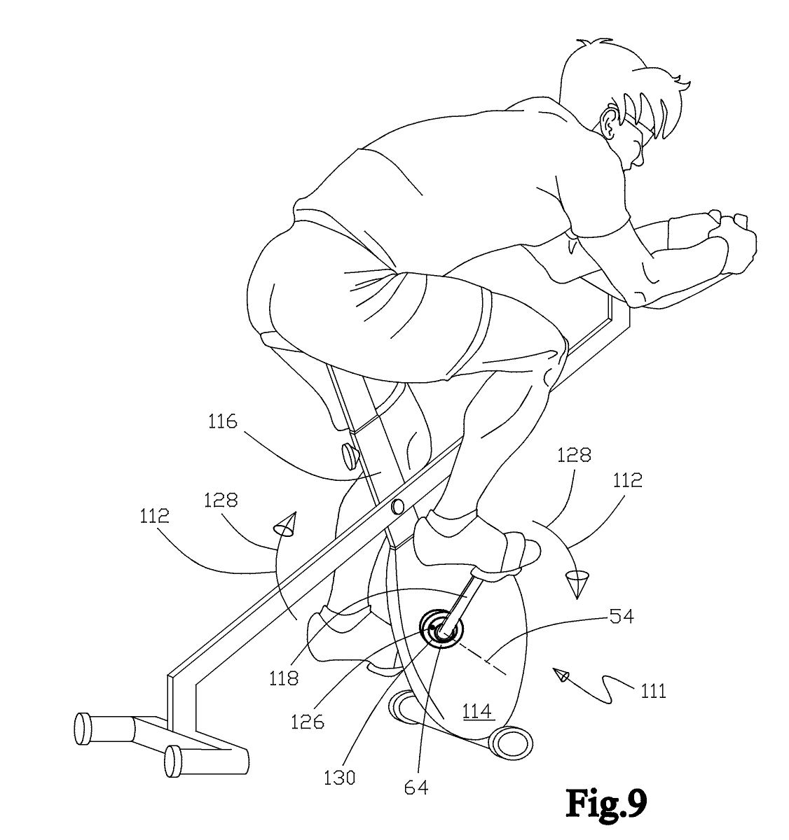

Yet, further FIG. 6 shows a cross sectional view of the rotational resistance apparatus 111 for use in the physical conditioning machine 114, specifically a “spinning” stationary exercise bike that includes the second means 126 for selectable axial urging of the cover 64 toward the disc 50. Continuing, FIG. 7 shows a cross sectional view of the rotational resistance apparatus 111 for use in the physical conditioning machine 114, specifically a “spinning” stationary exercise bike that further includes the third means 140 for selectable axial urging of the disc 50 toward the cover 64. Next, FIG. 8 shows a close up perspective view of the rotational resistance apparatus 111 as installed in the physical conditioning machine 114, or specifically a “spinning” stationary exercise bike and FIG. 9 shows a complete up perspective view of the rotational resistance apparatus 111 as installed in the physical conditioning machine 114, or specifically a “spinning” stationary exercise bike.

Further in detail, in focusing specifically on FIGS. 1 to 5 and in particular FIGS. 1 and 2, the present invention of the rotational resistance apparatus 30 to further control movement 32 of a carriage 34 across a surface 44, includes a disc 50 having an axial rotational axis 52, with the disc 50 having an axial first end portion 56 and an axial second end face portion 58 that is substantially perpendicular 60 to the axial rotational axis 52. Wherein, the first end portion 56 of the disc 50 is adapted to rotationally engage 62 a rotating element 38 of the carriage 34 all along a stationary axle 43 that is longitudinally rotating about axes 52 and 66, thus the disc 50 rotates with the rotating element 38. Also included, is a cover 64 having an axial longitudinal axis 66, the cover 64 having an axial outer end portion 68 that is adapted to removably engage 70 a frame 36 of the carriage 34 and an axial inner face portion 72 that is substantially perpendicular 74 to the longitudinal axis 66. Wherein the longitudinal axis 66 is approximately co-axial 76 to the axial rotational axis 52 and the cover 64 axial inner face portion 72 and the disc 50 axial second end face portion 58 are in a selected rotational frictional contact 78, thus the cover 64 is essentially rotationally static being removably engaged to the frame 36. Further included, is a first means 80 for selectable axial urging of the cover 64 toward the disc 50 along the axial longitudinal axis 66 that is operational to further selectably alter the selected rotational frictional contact 78. This results in the rotational resistance apparatus 30 being operational to further control movement 32 of the carriage 34 across the surface 44 via the selected rotational frictional contact 78 of the rotating element 38 as between the surface 44 and the frame 36 of the carriage 34.

On the rotational resistance apparatus 30, the preferred materials of construction for the disc 50 are carbon steel, alternative materials of construction would include aluminum or titanium, or any other materials that would be acceptable for the use as described in providing rotational resistance by way of surface friction per ordinary materials engineering standards. Further, the preferred materials of construction for the cover 64 are aluminum; alternative materials of construction would include steel or titanium, or any other materials that would be acceptable for the use as described in providing rotational resistance by way of surface friction per ordinary materials engineering standards.

Optionally, in focusing in particular on FIG. 1, the rotational resistance apparatus 30 can further include a washer 82 positioned in between the disc 50 second end face portion 58 and the cover 64 inner face portion 72, with the washer 82 being operational to further yet selectably control the selected rotational frictional contact 78. Thus, the washer 82 as being sandwiched between the disc 50 and the cover 64 is not necessarily rotationally engaged at all and operates at a rotational speed that is between the rotational speed of the disc 50 and the cover 64. Also, the washer 82 can be constructed of a sacrificial material component that is replaceable periodically to help preserve the disc 50 end face portion 58 and the cover 64 inner face portion 72 for a longer operational life at a selected rotational frictional contact 78. The preferred materials of construction for the washer 82 are Nylon, alternative materials of construction would include high melting point plastics or an oil impregnated silicone disk, or any other materials that would be acceptable for the use as described in providing rotational resistance by way of surface friction per ordinary materials engineering standards. The typical normal force or axial urging 90 is typically in the range of about fifteen pounds force which is essentially compressing the disc 50 and the cover 64 toward one another with the optional washer 82 interposed therebetween, with the result of varying the rotational frictional force as between the disc 50 and the cover 64 about axes 52 and 66 as per the known engineering equation of frictional force equaling the material dynamic coefficient of friction times the normal force converted through a moment arm to rotational resistance in a torque or normally expressed in foot-pounds.

Note however, that the force 90 could be more or less than fifteen pounds. Thus, the rotational frictional force as between the disc 50 and the cover 64 about axes 52 and 66 can be varied by the normal force 90 and the choice of materials for the disc 50, cover 64, and optionally the washer 82, that can have varying static/dynamic (kinematic) coefficients of friction, which are preferably for the disc 50 and the cover 64; each being constructed of aluminum are about 1.15 static and about 1.4 kinematic; and each with one constructed of aluminum or steel for an aluminum/steel interface are about 0.6 static and about 0.5 kinematic, further if a nylon or similar material washer 82 is interposed in-between the disc 50 and the cover 64; with the coefficient of friction being about 0.3 static and about 0.2 kinematic. However, other dynamic coefficients of friction would be acceptable as desired for the disc 50, cover 64, and washer 82. The typical rotational frictional force is about 0.06 foot-pounds, however noting that the rotational frictional force could be desirably more or less depending upon the force 90 and the coefficients of friction of the components being the disc 50, cover 64, and optional washer 82. The rotational (dynamic) frictional force of about 0.06 foot-pounds was determined from empirical testing using a force 90 of fifteen pounds and an aluminum cover 64, a stainless steel disc 50, and a nylon washer 82. There is some quantity of frictional heat to be dissipated as surface temperature of the cover 64 can reach about one hundred and twenty degrees Fahrenheit, however, as the frictional heat is generated from manual energy input from a human typically, the frictional waste heat is normally adequately dissipated by heat transfer from conduction, convection, and radiation to the surrounding atmosphere from the disc 50, cover 64, and possible washer 82.

Again, looking specifically at FIG. 1, the first means 80 for selectable axial urging preferably includes a shouldered sleeve 84 that is positioned adjacent to the cover 64 axial outer end portion 68, with the shouldered sleeve 84 being adapted to removably engage 86 the frame 36 resulting in being operational to substantially prevent relative rotational movement between the frame 36 and the shouldered sleeve 84, however, allowing axial separation along longitudinal axis 66 between the frame 36 and the shouldered sleeve 84. Also, preferably included in the first means 80 for selectable axial urging 90 is a first member 88 that is operational to selectably axially urge along longitudinal axis 66 the shouldered sleeve 84 and the cover 64 axial outer end portion 68 axially apart from one another substantially along the axial longitudinal axis 66. As the shouldered sleeve 84 is axially braced as against the frame 36, when the shouldered sleeve 84 and the cover 64 are axially urged apart along longitudinal axis 66 this results in the cover 64 being axially driven towards the disc 50 along longitudinal axis 66 that increases the normal force or contact pressure between the inner face portion 72 of the cover 64 and the end face portion 58 of the disc 50 thus increasing the friction between the cover 64 that is relatively stationary with the frame 36 and the rotating disc 50 that rotates with the rotating element 38, hence resulting in further controlling the movement 32 of the carriage 34 across the surface 44. Also on the rotational resistance apparatus 30, the preferred materials of construction for the shouldered sleeve 84 are aluminum, alternative materials of construction would include stainless steel, titanium, or composites, or any other materials that would be acceptable for the use as described in providing force 90 per ordinary materials engineering standards.

Further, in continuing to focus on FIG. 1, the rotational resistance apparatus 30 shouldered sleeve 84 that is adapted to removably engage 86 the frame 36 is preferably constructed of a serrated surface interface 92 between the shouldered sleeve 84 and the frame 36. Continuing, the serrated surface interface 92 is positioned in a plane 94 that is substantially perpendicular 96 to the axial longitudinal axis 66, the serrated surface interface 92 is operational to be removably engagable 98 to the frame 36 along the axial longitudinal axis 66 while substantially maintaining the rotational engagement between the frame 36 and the shouldered sleeve 84 about longitudinal axis 66. Preferably, the first member 88 is a first manually adjustable screw 100 that is threadably engaged 102 to the shouldered sleeve 84, in addition, the first manually adjustable screw 100 is also rotationally received 106 into a cavity 104 disposed on the cover 64 axial outer end portion 68. Wherein, the rotational reception 106 acts to substantially rotationally lock the cover 64 outer end portion 68 and the shouldered sleeve 84 about the longitudinal axis 66. The screw 100 is preferably a number 10-24 thread socket head cap screw that may have self locking threads that is constructed of a weather proof plated carbon steel or any other alternative configuration and material wise that would functionally urge the cover 64 and the shouldered sleeve 84 apart along longitudinal axis 66 as previously described.

Referring next again to FIGS. 1 and 2, further in focusing upon the disc 50 and specifically the first end portion 56 that is adapted to rotationally engage about rotational axis 52 a rotating element 38 that is sized and configured to preferably be an interference or shrink fit 108 between the disc first end portion 56 and a wheel hub 40 of the rotating element 38 that is rotationally attached 42 to the frame 36 of the carriage 34. Thus, the interference fit 108 forms the rotational engagement 62 of the first end portion 56 of the disc 50 to the rotating element 38 of the carriage 34. Continuing, on the interference fit 108 it is preferably of a substantially cylindrical configuration 110 that is approximately about the axial rotational axis 52. As the interference fit 108 is in a cylindrical configuration 110 the interference fit 108 would comprise the disc being slightly larger than the receiving hub 40 bore to create a sufficient contact pressure as between the assembled disc 50 and the hub 40 to have a rotational engagement 62 about rotational axis 52. Alternatively, the rotational engagement 62 could be a spline, key, or any other type of rotationally engaging 62 drive as between the hub 40 driving the disc 50.

The carriage 34 is shown preferably as a bicycle in referring to FIGS. 3, 4, and 5, with the rotating element 38 being a rear bicycle wheel 39, with the rotational resistance apparatus 30 being acceptably positioned on either axial side of the wheel hub 40, further the front bicycle wheel could also be utilized to mount the rotational resistance apparatus 30, again on either axial side of the wheel hub 40. In addition, the carriage 34 can be other than a bicycle, as an example a wheel chair, push cart, a baby stroller, or any other manually powered or pushed carriage across a surface 44, wherein a desire is present to control the movement 32 of the carriage 34 across the surface 44 with rotational resistance movement 45 of the rotating element 38.

In looking at FIGS. 6 to 9, an alternative embodiment of the rotational resistance apparatus 111 is disclosed to provide resistive force 112 as against exercise movement in a physical conditioning machine 114. The alternative embodiment of the rotational resistance apparatus 111 includes a disc 50 having an axial rotating structure axis 54, the disc 50 including an axial first end portion 56 and an axial second end face portion 58 that is substantially perpendicular 61 to the axial rotating structure axis 54, wherein the first end portion 56 is adapted to rotationally engage 122 to a housing 116 of the physical conditioning machine 114, thus the disc 50 is substantially rotationally static. Further included in alternative embodiment of the rotational resistance apparatus 111 is a cover 64 that is positioned about the axial rotating structure axis 54, the cover 64 including an axial outer end portion 68 that is adapted to rotationally engage 124 to a rotating structure 118 of the physical conditioning machine 114 and an axial inner face portion 72 that is substantially perpendicular 125 to the axial rotating structure axis 54, thus the cover 64 rotates with the rotating structure 118. Wherein the cover 64 axial inner face portion 72 and the disc 50 axial second end face portion 58 are in a selected rotational frictional contact 78. The alternative embodiment of the rotational resistance apparatus 111 further includes a second means 126 for selectable axial urging of the cover 64 toward the disc 50 along the axial rotating structure axis 54 that is operational to further selectably alter the selected rotational frictional contact 78 when the rotating structure 120 is in a static state, due to the second means 126 needing to be static for manual adjustment to occur, with the second means 126 operationally resulting in the rotational resistance apparatus 111 being operational to further increase or decrease the resistive force 112 as against exercise movement 128 in the physical conditioning machine 114 via the selected rotational frictional contact 78 of the rotating structure 118 relative to the housing 116 of the physical conditioning machine 114.

On the rotational resistance apparatus 111, the preferred materials of construction for the disc 50 are stainless steel, alternative materials of construction would include carbon steel, or alternatively aluminum or titanium, or any other materials that would be acceptable for the use as described in providing rotational resistance by way of surface friction per ordinary materials engineering standards. Further, the preferred materials of construction for the cover 64 are aluminum; alternative materials of construction would include steel or titanium, or any other materials that would be acceptable for the use as described in providing rotational resistance by way of surface friction per ordinary materials engineering standards.

Optionally, in focusing in particular on FIGS. 6 and 7, the rotational resistance apparatus 111 can further include a washer 82 positioned in between the disc 50 second end face portion 58 and the cover 64 inner face portion 72, with the washer 82 being operational to further yet selectably control the selected rotational frictional contact 78. As the washer 82 is sandwiched between the disc 50 and the cover 64, the washer 82 is not necessarily rotationally engaged at all operating at a rotational speed between the disc 50 and the cover 64. Also, the washer 82 can be constructed of a sacrificial material component that is replaceable periodically to help preserve the disc 50 end face portion 58 and the cover 64 inner face portion 72 for a longer operational life at a selected rotational frictional contact 78. The preferred materials of construction for the washer 82 are Nylon, alternative materials of construction would include a high melting point plastic, an oil impregnated silicone disc, or any other materials that would be acceptable for the use as described in providing rotational resistance by way of surface friction per ordinary materials engineering standards. The typical normal force or axial urging 135 is typically in the range of fifteen pounds normal force which is essentially compressing the disc 50 and the cover 64 toward one another with the optional washer 82 interposed therebetween, with the result of varying the rotational frictional force as between the disc 50 and the cover 64 about the rotating structural axis 54 as per the known engineering equation of frictional force equaling the material dynamic coefficient of friction times the normal force converted through a moment arm to rotational resistance in a torque or normally expressed in foot-pounds.

Thus, the rotational frictional force as between the disc 50 and the cover 64 about axis 54 can be varied by the normal force 135 and the choice of materials for the disc 50, cover 64, and optionally the washer 82, that can have varying dynamic coefficients of friction, which is preferably about 0.05 for the disc 50, for the cover 64, and for the washer 82 disposed therebetween all combined wherein the disc is stainless steel, the cover is aluminum, and the washer is Nylon. However, other dynamic coefficients of friction would be acceptable as desired for the disc 50, cover 64, and washer 82 that would coincide with materials changes, surface treatment changes, and the like. The typical rotational frictional force is about 0.06 foot-pounds. There is some quantity of frictional heat to be dissipated as surface temperature of the cover 64 can reach about one hundred and twenty degrees Fahrenheit, however, as the frictional heat is generated from manual energy input from a human typically, the frictional waste heat is normally adequately dissipated by heat transfer from conduction, convection, and radiation to the surrounding atmosphere from the disc 50, cover 64, and possible washer 82.

Again, looking specifically at FIGS. 6 and 7, the second means 126 for selectable axial urging preferably includes an annular ring 130 that is positioned adjacent to the cover 64 axial outer end portion 68, with the annular ring 130 being adapted to attach 132 and thus rotationally engaging to the rotating structure 118 of the physical conditioning machine 114. Also, preferably included in the second means 126 for selectable axial urging 135 is a second member 134 that is operational to selectably axially urge 135 along the rotational structural axis 54 the annular ring 130 and the cover 64 axial outer end portion 68 axially apart from one another substantially along the axial rotating structural axis 54. As the annular ring 130 is also axially attached 132 along the rotational structure axis 54, when the annular ring 130 and the cover 64 are axially urged apart along rotational structural axis 54 this results in the cover 64 being axially driven towards the disc 50 along the rotational structural axis 54 that increases the normal force or contact pressure between the inner face portion 72 of the cover 64 and the end face portion 58 of the disc 50 thus increasing the friction between the cover 64 that is in rotational engagement to the rotating structure 118 by way of the second member 134 being received in cavity 104 and the stationary disc 50 that in rotationally engaged 122 to the housing 116, hence resulting in further controlling the resistive force 112 and 128 of the physical conditioning machine 114. Also on the rotational resistance apparatus 111, the preferred materials of construction for the shouldered annular ring 130 are aluminum, alternative materials of construction would include stainless steels, titanium, a composite, or any other materials that would be acceptable for the use as described in providing force 90 per ordinary materials engineering standards.

In looking at FIG. 6, the second member 134 is preferably a first manually adjustable screw 138 that is threadably engaged 137 to the annular ring 130, in addition, the second manually adjustable screw 138 is also rotationally received 139 into a cavity 136 disposed on the cover 64 axial outer end portion 68. Wherein, the rotational reception 106 acts to substantially rotationally lock the cover 64 outer end portion 68 and the annular ring 130 with the rotating structure 118 about the rotational structural axis 54. The screw 138 is preferably a number 10-24 thread socket head cap screw that may have self locking threads that is constructed of a weather proof plated carbon steel or any other alternative configuration and material wise that would functionally urge the cover 64 and the annular ring 130 apart along rotating structural axis 54 as previously described.

Looking specifically to FIG. 7, the rotational resistance apparatus 111 can optionally further comprise a third means 140 for selectable axial urging of the disc 50 toward the cover 64 along the axial rotating structure axis 54 that is operational to further selectably alter the selected rotational frictional contact 142 when the rotating structure 118 is in the static state 120 or in a dynamic state, resulting in the rotational resistance apparatus 111 being operational to further increase or decrease the resistive force 112 and 128 as against exercise movement in the physical conditioning machine 114 via the selected rotational frictional contact 78 and 142 of the rotating structure 118 relative to the housing 116 of the physical conditioning machine 114. Continuing, the rotational resistance apparatus 111 third means 140 for selectable axial urging of the disc 50 toward the cover 64 along the axial rotating structure axis 54 is preferably a manually adjustable screw 144 that is threadably engaged 143 to the housing, wherein the screw 144 is also rotationally in axial bearing 141 as against the disc 50 axial first end portion 56. As an option, a remote adjustment structure 162 for third means 140 for selectable axial urging of the disc 50 toward the cover 64 in shown in FIG. 7 that could be a handlebar mounted control or other type of remote control on the physical conditioning machine 114 that would effectuate adjusting of the third means 140 by way of initially adjusting 164 the third means 140 for selectable axial urging of the disc 50 toward the cover 64 for initial light rotational frictional contact between the cover 64 axial inner face portion 72 and the disc 50 axial second end face portion 58 and then adjusting 166 the third means 140 for selectable axial urging of the disc 50 toward the cover 64 for a frictional contact between the cover axial inner face portion 72 and the disc axial second end face portion 58 that results in the selected rotational frictional contact 142

Referring next again to FIGS. 6 and 7, and FIG. 7 in particular, further in focusing upon the disc 50 and specifically the first end portion 56 that is adapted to rotationally engage about rotating structure axis 54 the physical conditioning machine housing 116 is preferably sized and configured to be a rotational engagement 122 to the first end portion 56 of the disc 50 that can allow for axial movement along rotating structural axis 54 to further facilitate the axial bearing 141 of the third means 140 or preferably third screw 144 as against disc 50 first end portion 56, to allow the disc 50 to move toward the cover 64 from the third means 140. Thus the rotational engagement 122 could be a spline, key, or any other type of rotationally engaging 62 drive as between the hub 40 driving the disc 50 that can further allow axial movement of the disc 50 along the rotating structural axis 54 relative to the housing 116. Further, the third means 140, as with the second means 126, and the first means 80 the normal force 90 and 135 can both be increased or decreased that corresponds to an increase or decrease ultimately in rotational frictional force of the rotating element 38 or the rotating structure 118.

### Method of Use

Referring in particular to FIGS. 3 to 5, and also referring to FIGS. 1 and 2, a method of further controlling movement of a carriage 34 across a surface 44, includes the steps of firstly providing a rotational resistance apparatus 30 to further control movement 32 of a carriage 34 across a surface 44, that includes a disc 50 having an axial rotational axis 52, with the disc 50 having an axial first end portion 56 and an axial second end face portion 58 that is substantially perpendicular 60 to the axial rotational axis 52. Wherein, the first end portion 56 of the disc 50 is adapted to rotationally engage 62 a rotating element 38 of the carriage 34. Also included, is a cover 64 having an axial longitudinal axis 66, the cover 64 having an axial outer end portion 68 that is adapted to removably engage 70 a frame 36 of the carriage 34 and an axial inner face portion 72 that is substantially perpendicular 74 to the longitudinal axis 66. Wherein the longitudinal axis 66 is approximately co-axial 76 to the axial rotational axis 52 and the cover 64 axial inner face portion 72 and the disc 50 axial second end face portion 58 are in a selected rotational frictional contact 78. Further included, is a first means 80 for selectable axial urging of the cover 64 toward the disc 50 along the axial longitudinal axis 66 that is operational to further selectably alter the selected rotational frictional contact 78. This results in the rotational resistance apparatus 30 being operational to further control movement 32 of the carriage 34 across the surface 44 via the selected rotational frictional contact 78 of the rotating element 38 as between the surface 44 and the frame 36 of the carriage 34.

Looking in particular at FIG. 2, a next step of positioning 146 the disc 50 to rotationally engage 70 the rotating element 38 of the carriage 34, and looking at FIG. 1 continuing further a step of positioning 148 the cover 64 to removably engage 70 the frame 36 of the carriage 34. Continuing to refer to FIG. 1, a subsequent step of adjusting 150 the first means 80 for selectable axial urging 90 of the cover 64 toward the disc 50 such that there is an initial light rotational frictional contact between the cover 64 axial inner face portion 72 and the disc 50 axial second end face portion 58. Next referring to FIGS. 1, and 3 to 5, moving 152 the carriage 34 across the surface 44 utilizing a selected manual motivation level and recording a first velocity 46 of the carriage 34 across the surface 44. Then a further step of again adjusting 154 the first means 80 for selectable axial urging 90 of the cover 64 toward the disc 50 such that the carriage 34 is moving at a selected second velocity 48 across the surface 44 with the selected manual motivation level.

Optionally, in referring to FIG. 1, on the method of further controlling movement of the carriage 34 across the surface 44 a further step of adding 156 a washer 82 in between the cover 64 axial inner face portion 72 and the disc 50 axial second end face portion 58, wherein the washer 82 is operational to further control 32 the selected rotational frictional contact 78 by being a sacrificial component. Also, optionally the steps of moving 152 the carriage 34 and adjusting 154 the first means 80 can be sequentially repeated to further achieve the selected second velocity 48 of the carriage 34 across the surface 44 with the selected manual motivation level.

### CONCLUSION

Accordingly, the present invention of a rotational resistance apparatus 30 or the alternative embodiment of the rotational resistance apparatus 111 has been described with some degree of particularity directed to the embodiment(s) of the present invention. It should be appreciated, though; that the present invention is defined by the following claims construed in light of the prior art so modifications or changes may be made to the exemplary embodiment(s) of the present invention without departing from the inventive concepts contained therein.

1. A rotational resistance apparatus to further control movement of a carriage across a surface, comprising:
(a) a disc having an axial rotational axis, said disc including an axial first end portion and an axial second end face portion that is substantially perpendicular to said axial rotational axis, wherein said first end portion is adapted to rotationally engage a rotating element of the carriage;
(b) a cover having an axial longitudinal axis, said cover including an axial outer end portion that is adapted to removably engage a frame of the carriage and an axial inner face portion that is substantially perpendicular to said longitudinal axis, wherein said longitudinal axis is approximately co-axial to said axial rotational axis and said cover axial inner face portion and said disc axial second end face portion are in a selected rotational frictional contact; and
(c) a first means for selectable axial urging of said cover toward said disc along said axial longitudinal axis that is operational to further selectably alter said selected rotational frictional contact, resulting in said rotational resistance apparatus being operational to further control movement of the carriage across the surface via said selected rotational frictional contact of the rotating element as between the surface and the frame of the carriage.

2. A rotational resistance apparatus according to claim 1 further comprising a washer positioned in between said disc second end face portion and said cover inner face portion, said washer is operational to further yet selectably control said selected rotational frictional contact.

3. A rotational resistance apparatus according to claim 2 wherein said washer is constructed of a sacrificial material that is operational to further maintain said selected rotational frictional contact.

4. A rotational resistance apparatus according to claim 1 wherein said first means for selectable axial urging includes a shouldered sleeve that is positioned adjacent to said cover axial outer end portion, said shouldered sleeve is adapted to removably engage the frame and also includes a first member that is operational to selectably axially urge said shouldered sleeve and said cover axial outer end portion axially apart from one another substantially along said axial longitudinal axis.

5. A rotational resistance apparatus according to claim 4 wherein said shouldered sleeve that is adapted to removably engage the frame is constructed of a serrated surface interface between said shouldered sleeve and the frame.

6. A rotational resistance apparatus according to claim 5 wherein said serrated surface interface is positioned in a plane that is substantially perpendicular to said axial longitudinal axis, said serrated surface interface is operational to be removably engagable to the frame along said axial longitudinal axis.

7. A rotational resistance apparatus according to claim 4 wherein said first member is a first manually adjustable screw that is threadably engaged to said shouldered sleeve, said first manually adjustable screw is also rotationally received into a cavity disposed on said cover axial outer end portion.

8. A rotational resistance apparatus according to claim 1 wherein said disc first end portion that is adapted to rotationally engage a rotating element is sized and configured to be an interference fit between said disc first end portion and a wheel hub of the rotating element that is rotationally attached to the frame of the carriage.

9. A rotational resistance apparatus according to claim 8 wherein said interference fit has a substantially cylindrical configuration that is approximately about said axial rotational axis.

10. A rotational resistance apparatus to provide resistive force as against exercise movement in a physical conditioning machine, comprising:
(a) a disc having an axial rotating structure axis, said disc including an axial first end portion and an axial second end face portion that is substantially perpendicular to said axial rotating structure axis, wherein said first end portion is adapted to rotationally engage to a housing of the physical conditioning machine;
(b) a cover that is positioned about said axial rotating structure axis, said cover including an axial outer end portion that is adapted to rotationally engage to a rotating structure of the physical conditioning machine and an axial inner face portion that is substantially perpendicular to said axial rotating structure axis, wherein said cover axial inner face portion and said disc axial second end face portion are in a selected rotational frictional contact; and
(c) a second means for selectable axial urging of said cover toward said disc along said axial rotating structure axis that is operational to further selectably alter said selected rotational frictional contact when the rotating structure is in a static state, resulting in said rotational resistance apparatus being operational to further increase or decrease the resistive force as against exercise movement in the physical conditioning machine via said selected rotational frictional contact of the rotating structure relative to the housing of the physical conditioning machine.

11. A rotational resistance apparatus according to claim 10 further comprising a washer positioned in between said disc second end face portion and said cover inner face portion, said washer is operational to further yet selectably control said selected rotational frictional contact.

12. A rotational resistance apparatus according to claim 11 wherein said washer is constructed of a sacrificial material that is operational to further maintain said selected rotational frictional contact.

13. A rotational resistance apparatus according to claim 10 wherein said second means for selectable axial urging includes an annular ring that is positioned adjacent to said cover axial outer end portion, said annular ring is adapted to attach to the rotating structure of the physical conditioning machine and also includes a second member that is operational to selectably axially urge said annular ring and said cover axial outer end portion axially apart from one another substantially along said axial rotating structure axis.

14. A rotational resistance apparatus according to claim 13 wherein said member is a second manually adjustable screw that is threadably engaged to said annular ring, said second manually adjustable screw is also rotationally received into a cavity disposed on said cover axial outer end portion.

15. A rotational resistance apparatus according to claim 10 further comprising a third means for selectable axial urging of said disc toward said cover along said axial rotating structure axis that is operational to further selectably alter said selected rotational frictional contact when the rotating structure is in said static state or in a dynamic state, resulting in said rotational resistance apparatus being operational to further increase or decrease the resistive force as against exercise movement in the physical conditioning machine via said selected rotational frictional contact of the rotating structure relative to the housing of the physical conditioning machine.

16. A rotational resistance apparatus according to claim 15 wherein said third means for selectable axial urging of said disc toward said cover along said axial rotating structure axis is a manually adjustable screw that is threadably engaged to the housing, wherein said screw is also rotationally in axial bearing as against said disc axial first end portion.

17. A method of further controlling movement of a carriage across a surface, comprising the steps of:
(a) providing a rotational resistance apparatus that includes a disc having an axial rotational axis, said disc including an axial first end portion and an axial second end face portion that is substantially perpendicular to said axial rotational axis, wherein said first end portion is adapted to rotationally engage a rotating element of the carriage, also included in said rotational resistance apparatus is a cover having an axial longitudinal axis, said cover including an axial outer end portion that is adapted to removably engage to a frame of the carriage and an axial inner face portion that is substantially perpendicular to said longitudinal axis, wherein said longitudinal axis is approximately co-axial to said rotational axis and said cover axial inner face portion and said disc axial second end face portion are in a selected rotational frictional contact, further included in said rotational resistance apparatus is a first means for selectable axial urging of said cover toward said disc along said axial longitudinal axis that is operational to further selectably alter said selected rotational frictional contact, resulting in said rotational resistance apparatus being operational to further control movement of the carriage across the surface via said selected rotational frictional contact of the rotating element as between the surface and the frame of the carriage;
(b) positioning said disc to rotationally engage the rotating element of the carriage;
(c) positioning said cover to removably engage the frame of the carriage;
(d) adjusting said first means for selectable axial urging of said cover toward said disc such that there is an initial light rotational frictional contact between said cover axial inner face portion and said disc axial second end face portion;
(e) moving the carriage across the surface utilizing a selected manual motivation level and recording a first velocity of the carriage across the surface; and
(f) adjusting said first means for selectable axial urging of said cover toward said disc such that the carriage is moving at a selected second velocity across the surface with said selected manual motivation level.

18. A method of further controlling movement of a carriage across a surface according to claim 17 further comprising a step of adding a washer in between said cover axial inner face portion and said disc axial second end face portion, wherein said washer is operational to further control said selected rotational frictional contact by being a sacrificial component.

19. A method of further controlling movement of a carriage across a surface according to claim 17 further comprising steps of sequentially repeating said steps (e) and (f) to further achieve said selected second velocity of the carriage across the surface with said selected manual motivation level.
